(19) United States
(12) Patent Application Publication
(10) Pub. No.: US 2004/0073713 A1
(43) Pub. Date: Apr. 15, 2004

(54) Method, system, gateway, proxy and computer program for adding information to received content pages

(76) Inventors: Pasi Pentikainen, Tampere (FI); Erno Zalka, Budapest (HU)

Correspondence Address: HARRINGTON & SMITH, LLP, 4 RESEARCH DRIVE, SHELTON, CT, 06484-6212, US

(21) Appl. No.: 10/451,691

(22) PCT Filed: Dec. 13, 2001
(86) PCT No.: PCT/FI01/01095

(30) Foreign Application Priority Data
Dec. 21, 2000 (FI) 20002823

(51) Int. Cl. G06F 15/16

(52) U.S. Cl. 709/249; 709/219

(57) ABSTRACT

A method is provided for mobile terminals (106) to request WAP content from a network (102). The network comprises a gateway (106) via which a mobile terminal having a display can access a plurality of content servers (110, 118) each having stored therein content pages. The network is run by a network operator. The mobile terminal sends a request to the gateway for a content page to be provided by one of the content servers and the gateway obtains the content page and provides it to the mobile terminal. Before doing this, the gateway uses a WAP content proxy (112) to insert into the content page a link to a home page of the network operator which thus enables a user of the mobile terminal always to have presented a link option to go to the network operator's home page.

The invention relates to data transmission systems and is particularly, but not exclusively, related to wireless communications systems. In one embodiment it is related to a method and apparatus in a wireless communications system for controlling display of data in the form of content pages by a portable subscriber unit such as a mobile telephone.

In the Internet, content is stored in content servers which are accessible by entering their Universal Resource Locator (URL) into a browser. In accessing content from the Internet, typically in the form of content pages, a terminal such as a personal computer (PC) is connected directly to a content server or is connected to a content server via a proxy. Terminals and content servers/proxies communicate directly via the transport control protocol/internet protocol (TCP/IP), and so it is not necessary for the terminal to be directed through a specific gateway in order to access the content. A gateway is an entity which links two networks together, the networks communicating by different protocols, and translates data from one protocol into the other. Therefore, in using the terminal to browse the Internet, a user is not restricted to a specific gateway and so is able to navigate around freely and obtain content from whichever sites and use whichever portals are desired.

It is known for Internet portals to modify dynamically content pages accessed by users to match the users' interests better. For example, search queries in various of the search engines in the Internet modify content pages so as to include links to relevant Internet sites. This can be done by the search engine checking for particular search criteria and, if they are present, inserting into the content pages links to particular Internet sites.

It is becoming increasingly common for content to be provided to mobile terminals operating in mobile (wireless) communications systems. In this way, users of the mobile terminals can be provided with up-to-date information. Network operators are now providing information services relating to stocks, sports, news and the like. Initially, network operators provided such information services by using specific messaging services such as the short message service (SMS). More recently, mobile communications systems have begun to support mobile access to the Internet.

Various communications protocols, including the Wireless Application Protocol (WAP) have been developed to provide mobile access to the Internet. In communicating according to WAP, a mobile terminal communicates with a WAP gateway by means of WAP and the WAP gateway communicates with content servers via TCP/IP to obtain content in the form of wireless mark-up language (WML).

It is usual for the WAP gateway to send a default content page to the mobile terminal. Such a default content page (or home page) is typically configured by the network operator which controls the WAP gateway and may contain services or utilities which are useful to the user, for example a mailbox for electronic mail. In addition, the home page may provide common information or common applications (including links to advertisements) to users. The applications available to the mobile terminals may take the form of applications running on servers which are able to provide a user interface which is compatible with WAP so that the user is able to use the application by using the user interface available in the mobile terminal. The application may be in a very simple form, for example it may be static or it may contain a collection of links.

In accessing services via WAP from the Internet the user will use the mobile terminal to browse content pages and use applications from different Internet sites. Therefore, it is likely that the user will browse away from the home page and the utilities which it provides. From time to time, the user may desire to use one of the utilities available on the home page and so it is necessary to return to the home page to select that utility. Although it is known to provide functionality in mobile terminals for the home page to be permanently stored, it is possible for the user to change to a different default home page, perhaps as a matter of preference, in which case the user no longer has the option to return to the original home page. If the mobile terminal is provided with a “back” command then this will not take the user to the original home page if the user did not start from there. Once the “back” command is activated, the user is usually given the option of a “forward” command to return to the page from which the user has just come. In addition, if activities occur in relation to the user's home page, for example if mail is received, the user will not be notified of this fact if a different content page is being browsed at this time.

Currently, if a request is made in a mobile terminal to return to the home page, the content page currently being browsed is stored in the mobile terminal as a previous page. Thus, after reviewing the home page, if it is desired to return to the previous page, the terminal displays a cached version of the previous page or a URL for the previous page in the terminal is used to obtain the previous page.

An additional problem exists in relation to using small terminals to access the Internet. In browsing, a user will often find a content page to which, for one reason or another, it would be desirable to return. In this case, the user is able to record the address or the URL of such an address as a bookmark. However, it can be awkward and time-consuming to write out such addresses or URLs using the user interface of small terminals. For this reason, it has been proposed to allow a user to use the WWW to assemble list of bookmarks which can then be accessed via WAP. The main disadvantage of this approach is that a user must have access to a WWW terminal in order to add bookmarks in this way. Therefore, if the user finds interesting WAP content as a WAP terminal is being used for browsing, then a record of the URL of this content needs to be saved in order to be able to enter it into a WWW terminal.

According to a first aspect of the invention there is provided a method of data transmission between a network and a plurality of terminals, the network comprising a gateway via which a terminal having a display can access a plurality of data resources each having stored therein at least one content page, the method comprising the steps of:

the terminal sending a request to the gateway for at least one content page to be provided by at least one of the plurality of data resources;

the gateway providing the at least one content page to the terminal for display in the display of the terminal; and

the gateway inserting into the at least one content page which it provides to the terminal a link which enables the terminal to obtain data from a network address determined by the gateway.

An advantage of this arrangement is that a link to the home page may always be presented to a user irrespective of the content pages which the user is browsing.

Preferably the link is presented in the content page so that it is visible in the display. The link may only be presented in an options field associated with the content page. An advantage of this approach is that presentation of the link to the user is less invasive. Furthermore, such a content page may take up less memory space in the mobile terminal than if the link were to be presented in the content page itself. The link may be presented both in the content page itself and in the options field.

Preferably the link is to a home page. Preferably the home page is associated with the gateway. In this context, the term “home page” means a location at which is provided a collection of links, preferably to subscribers of the network operator. The links may lead to utilities, services and applications

Alternatively the link is to a network-based data resource. Activation of the link can enable a user to be able to add the address of the at least one content page being browsed to a list of favourite addresses, that is the address can be added as a bookmark. Preferably the terminal can access the network-based data resource to obtain access to the list of favourite addresses.

Preferably the terminal is a mobile terminal. Most preferably it is a mobile terminal having mobile telephone functionality. Preferably the network is a cellular network for transmitting telephone calls and/or data calls.

Preferably the plurality of data resources is a plurality of content servers in the Internet. Most preferably, the content servers are WAP application servers. Additionally or alternatively, data resources are provided in the form of content servers in the network. Each of the content servers, whether in the network or in the Internet, may have stored within it a plurality of pages of content.

Preferably a plurality of content pages are sent to the terminal. Preferably the content pages are WML pages. Preferably the gateway is owned by, or controlled by, an operator of the network. Alternatively, it may be owned by, or controlled by, another entity such as a bank or some other commercial enterprise. Preferably the network address is a home page provided by the entity which provides the gateway. Preferably the gateway and the terminal communicate by WAP.

Another advantage of the invention is that the gateway can be relatively stateless in that it does not have to keep a browsing history in order to provide additional services to the terminal. For example, if the terminal obtains data from a present network address different to the network address determined by the gateway, and then a request is sent to request data from the network address determined by the gateway, the request can contain information about the present network address and thus the network can provide services based on the present network address.

According to a second aspect of the invention there is provided a method of data transmission over a network controlled by a network operator, the network comprising a gateway via which a terminal having a display can access to a plurality of data resources each having stored therein at least one content page, the method comprising the steps of:

the terminal sending a request to the gateway for at least one content page to be provided by at least one of the plurality of data resources;

the gateway providing the at least one content page to the terminal for display in the display of the terminal; and

the gateway inserting into the at least one content page which it provides to the terminal an indicator which indicates information concerning a service provided by a service provider.

Preferably the indicator is a link to a network address owned by, or operated by, the network operator. The network address may be a portal. Activation of the link may provide a content page representing the portal. Preferably the indicator indicates that new mail has arrived into a mail server. Most preferably, it indicates that new mail has arrived into a mail server operated by, or controlled by, the network operator.

Preferably the indicator is presented in the content page so that the link is visible in the display. The indicator may only be presented in an options field associated with the content page. The indicator may be presented both in the content page itself and the options field.

Preferably the service provider is the network operator.

According to a third aspect of the invention there is provided a data transmission system comprising a network operator, the network comprising a gateway via which a plurality of terminals can access a plurality of data resources each having stored therein at least one content page, each of the terminals having a display, a browser and a transceiver, the browser and the transceiver being used by the terminal to send a request to the network for at least one content page to be provided by at least one of the plurality of data resources, the network receiving the request and providing the at least one content page to the terminal for display by the terminal, the gateway comprising a content proxy to insert into the at least one content page provided to the terminal an indicator which indicates information concerning a service provided by a service provider.

According to a fourth aspect of the invention there is provided a gateway for use in a network controlled by a network operator, the network being accessible by a plurality of terminals to access a plurality of data resources each having stored therein at least one content page, each of the terminals having a display, a browser and a transceiver, the browser and the transceiver being used by the terminal to send a request to the network for at least one content page to be provided by at least one of the plurality of data resources, the network receiving the request and providing the at least one content page to the terminal for display by the terminal, the gateway comprising a content proxy to insert into the at least one content page provided to the terminal an indicator which indicates information concerning a service provided by a service provider.

According to a fifth aspect of the invention there is provided a content proxy for use in a network controlled by a network operator, the network being accessible by a plurality of terminals to access a plurality of data resources each having stored therein at least one content page, each of the terminals having a display, a browser and a transceiver, the browser and the transceiver being used by the terminal to send a request to the network for at least one content page to be provided by at least one of the plurality of data resources, the network receiving the request and providing the at least one content page to the terminal for display by the terminal, the content proxy inserting into the at least one content page provided to the terminal an indicator which indicates information concerning a service provided by a service provider.

According to a sixth aspect of the invention there is provided a computer program product comprising a computer readable medium having thereon:

computer executable code means to provide a gateway for use in a network controlled by a network operator, the network being accessible by a plurality of terminals to access a plurality of data resources each having stored therein at least one content page;

computer executable code means to enable the gateway to receive from at least one of the terminals a request for at least one content page to be provided by at least one of the plurality of data resources;

computer executable code means to request the at least one content page;

computer executable code means to insert into the at least one content page which is provided to the at least one terminal an indicator which indicates information concerning a service provided by a service provider; and

computer executable code means to enable the gateway to provide the at least one content page to the terminal for display in the display of the at least one terminal.

Of course, if content in a form not requiring visual display is transmitted, then the terminals do not need displays to show the content and some other form of user interface may be used. For example, if the content may be presented in an audio form, then a loudspeaker (possibly in the form of a headset or an ear-piece) may be used as a user interface rather than a display. In this case, insertion of a link or an indicator would need to be in an appropriate, corresponding, form.

According to a seventh aspect of the invention there is provided a method of storing addresses of a plurality of data resources in a network-based data resource so that the addresses are available to a terminal having a display, the method comprising the steps of:

the terminal sending a request to a gateway for at least one content page to be provided by at least one of the plurality of data resources, the at least one content page having an address;

the gateway providing the at least one content page to the terminal for display in the display of the terminal;

the gateway inserting into the at least one content page which it provides to the terminal a link to the network-based data resource;

the terminal accessing the network-based data resource in order to transmit the address of the at least one content page to the network-based data resource;

storing the address of the at least one content page in the network-based data resource.

Preferably the link to the network-based data resource is an indirect link. For example, the link may give the user access to a page such as a homepage which itself provides a link giving access to the network-based data resource.

Preferably the invention relates to a method of data transmission between a network and a plurality of terminals. Preferably the network comprises a gateway via which the terminals can access a plurality of data resources each having stored therein at least one content page.

Preferably the terminal is a mobile terminal. It may comprise a mobile telephone. It may be a WAP terminal

Preferably the terminal accesses the network-based data resource by using WAP.

Preferably the addresses are selected as a result of a browsing operation and then are sent to the network-based data resource where they are stored.

Preferably the addresses of the data resources are URLs. Preferably the addresses are stored in the network-based data resource as bookmarks.

Preferably the addresses stored in the network-based data resource are accessible by activation of a link which is automatically inserted into content pages which are sent to the terminal. Preferably the link is inserted into all pages sent to the terminal. The link may be inserted by the gateway. Preferably the gateway is between a network which provides the content pages to the terminal and a network which retrieves content pages from the data resources.

Preferably the gateway is owned by, or controlled by, an operator of the network which provides the content pages to the terminal. Alternatively, it may be owned by, or controlled by, another entity such as a bank or some other commercial enterprise. Preferably the gateway and the terminal communicate by WAP.

Preferably a user can use the terminal to select WML pages.

Preferably the link is presented in the content page so that it is visible in the display. The link may only be presented in an options field associated with the content page. An advantage of this approach is that presentation of the link to the user is less invasive. Furthermore, such a content page may take up less memory space in the mobile terminal than if the link were to be presented in the content page itself. The link may be presented both in the content page itself and in the options field.

Preferably the addresses of the data resources are URLs. Preferably the addresses are stored in the network-based data resource as bookmarks.

Preferably the addresses are stored in a homepage of the user of the terminal. Preferably the addresses are a private collection, which is only accessible by the user of the terminal and/or by users who have been given permission.

The invention enables a user to save WAP URLs into a network data resource which are then accessible by a WAP terminal. This saves the user having to write long URLs into the WAP terminal in order for them to be saved in the WAP terminal.

According to an eighth aspect of the invention there is provided a network-based data resource for storing addresses of a plurality of data resources so that the addresses are available to a terminal having a display, wherein the terminal is capable of sending a request to a gateway for at least one content page to be provided by at least one of the plurality of data resources, the at least one content page having an address;

the gateway is capable of providing the at least one content page to the terminal for display in the display of the terminal; and

the gateway is capable of inserting into the at least one content page which it provides to the terminal a link to the network-based data resource; the network-based data resource comprising:

a port to receive the address of the at least one content page transmitted by the terminal;

a memory to store the address of the at least one content page in the network-based data resource.

The invention will now be described by way of example only with reference to the accompanying drawings in which:

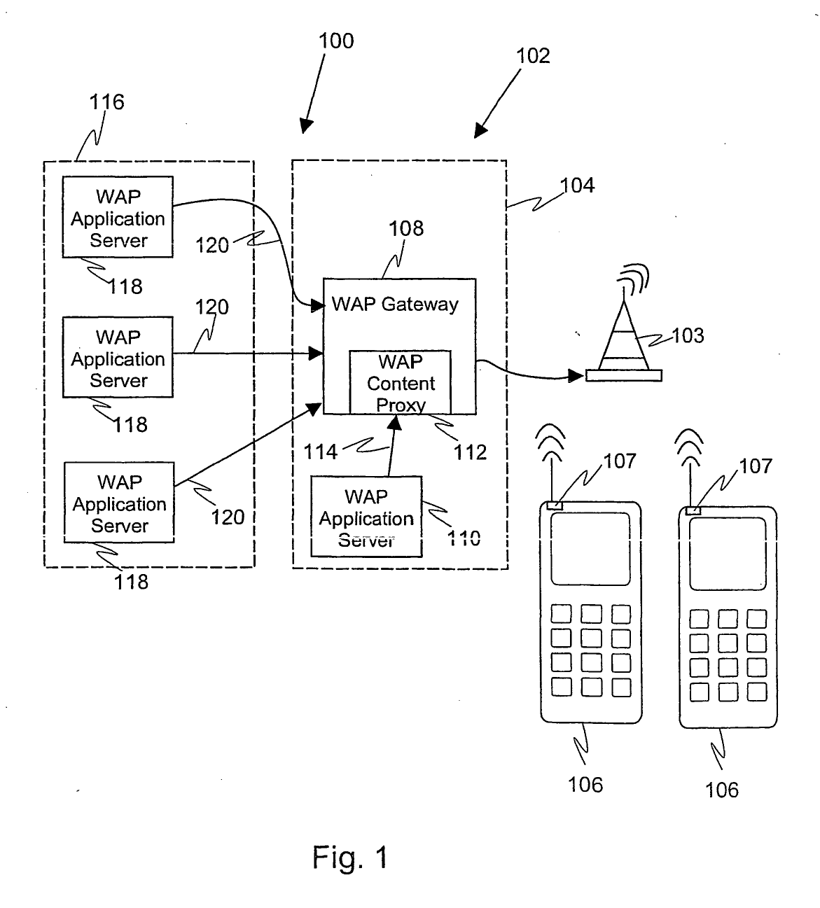

FIG. 1 shows a system according to the invention;

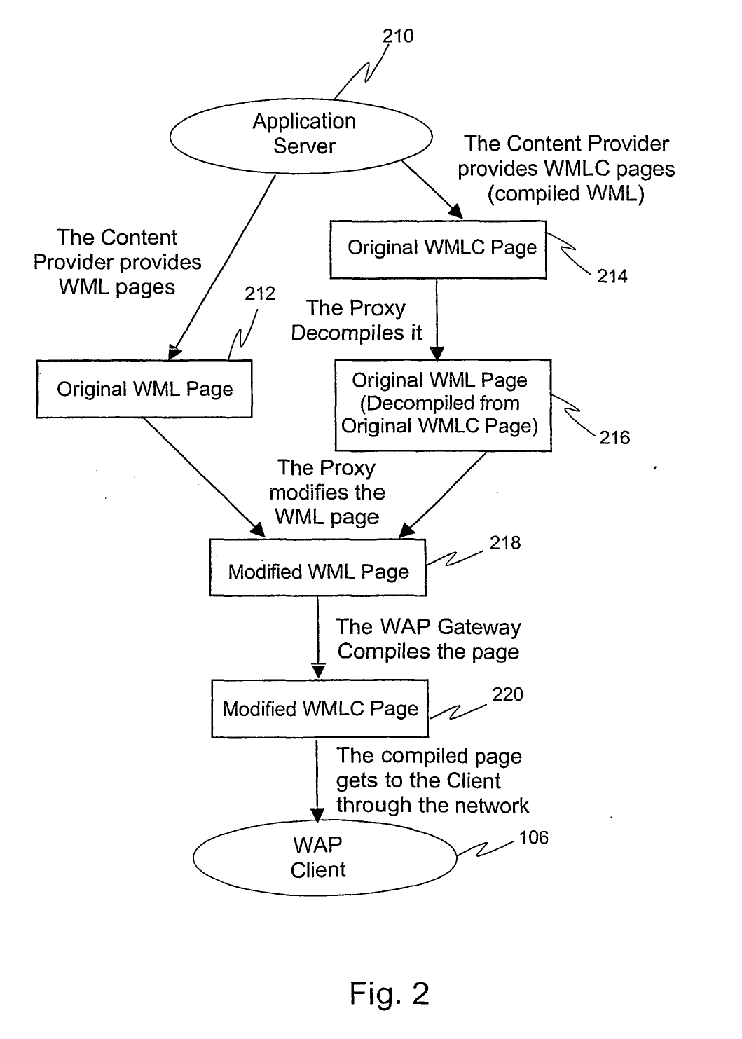

FIG. 2 shows modification of a content page by a WAP content proxy;

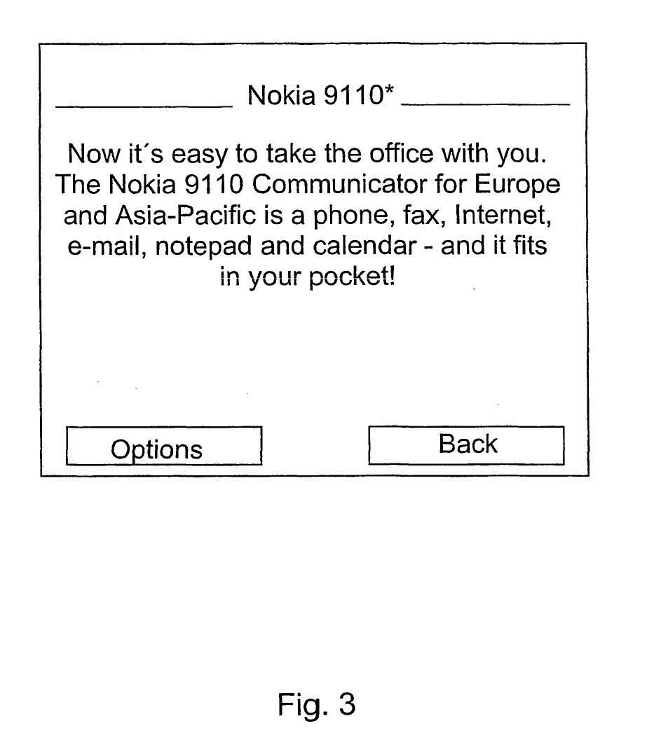

FIG. 3 shows a WML page;

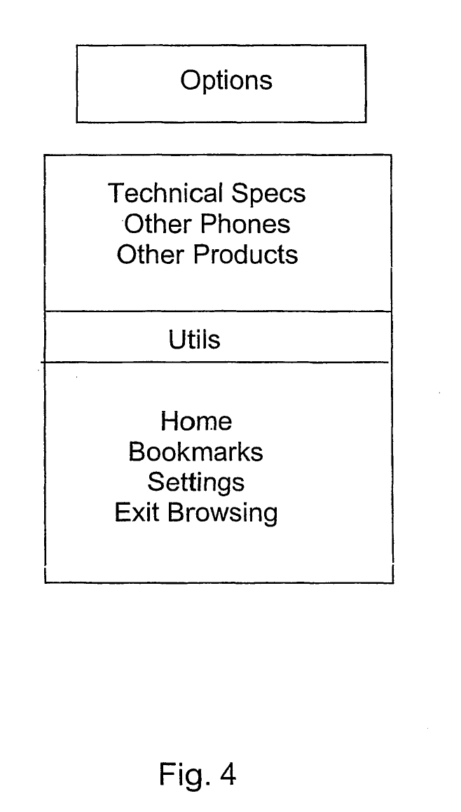

FIG. 4 shows an options menu available from the WML page of FIG. 3;

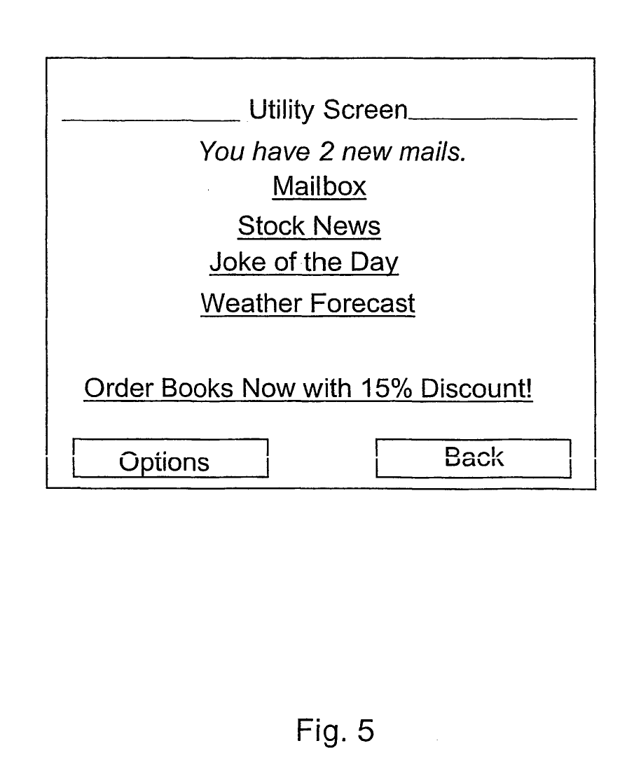

FIG. 5 shows a WML utility page available from the options menu in FIG. 4; and

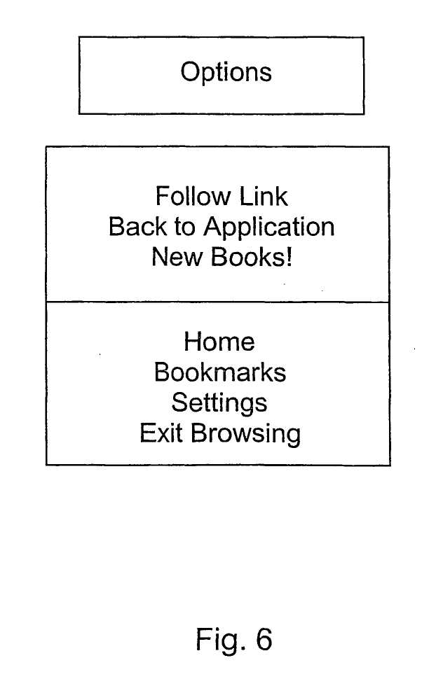

FIG. 6 shows an options menu available from the WML utility page of FIG. 5.

FIG. 1 shows a communications system 100 according to the invention. The system 100 comprises a mobile network side 102 under the control of a network operator comprising a plurality of base stations 103 and a content handling part 104. The mobile network side 102 is connected to a plurality of WAP terminals 106 over the air interface by wireless connections. The WAP terminals 106 are mobile terminals which are able to communicate with the mobile network side 102 via WAP. They have WAP browsers and transceivers to enable a wireless connection to be established with at least one of the base stations 103.

The content handling part 104 comprises a WAP gateway 108 and a WAP application server 110. The WAP gateway 108 comprises a WAP content proxy 112. The WAP content proxy 112 makes it possible to add additional content to WAP applications as will be described in the following. The additional content may include a link to a home page, the home page and information relating to advertisements and other matters.

The WAP application server 110 provides the additional content to the WAP terminals 106 via the WAP gateway 108 and the WAP content proxy 112. The additional content is provided over an intranet connection 114 and thus the WAP content proxy 112 and the WAP application server are an intranet environment.

The WAP gateway 108 is located at the mobile network side 102, and ultimately between the WAP terminals 106, and the Internet. The Internet is indicated by numeral 116. The internet 116 comprises a plurality of WAP application servers 118 controlled by content providers. The WAP application servers 118 are connected to the WAP gateway 108 by Internet connections 120.

When one of the WAP terminals 106 is used to obtain original content from the Internet, it establishes a WAP session with the WAP gateway 108. Once the session is established, the WAP terminal requests an initial WML page. The WAP gateway 108 gets the WML page and provides it to the WAP terminal 106. The WML page (which depends on what the WAP terminal 106 has requested) typically contains links to enable the user of the WAP terminal 106 to navigate to desired content.

Although initially the WAP terminal 106 may be configured to connect to the home page of the network operator, the user of the WAP terminal 106 may chose to configure as a default home page a home page which is not related to the WAP gateway 108. Therefore, the WAP content proxy 112 inserts an extra link into each WML page provided to the WAP terminal 106 which points to the home page of the network operator. In this way, the WAP terminal 106 can obtain access to links to various functions provided by the network operator. Such a function may be personal settings which determine the way in which content is configured or presented or both and may include such matters as language of text and colours of presentation. Since the extra link is provided in each content page, the user can access the home page of the network operator and thus have access these functions independently of the site or content page which is currently being browsed. Therefore, even if the user has configured a different home page into the WAP terminal 106, the user is always presented with a link to go back to the network operator's home page. The request for the home page of the network operator can also contain the URL address which the user is currently browsing. The significance of this will be described in the following. Once the user has accessed the home page, the user can then return to the interrupted application by a back command.

FIG. 2 shows modification of a content page by the WAP content proxy 112. A content page is retrieved from a WAP application server 210 in either the Internet or the intranet environment in either original form (WML) 212 or in compiled form (WMLC) 214. If the page is a WMLC page, it is decompiled by the WAP content proxy 112 to produce a WML page 216. In either case, a WML page is provided to the WAP content proxy 112 which then modifies it to provide a modified WML page 218 as will be described in the following. The modified WML page 218 is then compiled by the WAP gateway 108 to produce a modified WMLC page 220 which can then be provided to a WAP terminal 106 by the mobile network side 102. Modifications can be made directly to WMLC content provided if parsing is done on the compiled level (so the WMLC content does not have to be changed into WML).

FIG. 3 shows a WML page as presented by a browser in the display of a WAP terminal 106. The WML page has a heading, some text and menu selectors “Options” and “Back”. Selection of the menu selector “Options” changes the display to display three groups of available options, as shown in FIG. 4. The first group is options which have been placed by the WAP application being browsed and, in this case, includes “Technical Specs”, “Other Phones” and “Other Products”. The second group is options which have been placed by the WAP content proxy 112 and, in this case, includes “Utils”. The third group is options which have been placed by the browser of the WAP terminal 106, and, in this case, includes “Home”, “Bookmarks”, “Settings” and “Exit Browsing”. The modification which is carried out by the WAP content proxy 112 is the inclusion of the second group, that is the addition of the link “Utils”.

The deck source of the WML page and options list in FIGS. 3 and 4 is shown below:

<?xml version=“1.0”?>
<!DOCTYPE wml PUBLIC “-//WAPFORUM//DTD WML 1.1//EN”
“http://www.wapforum.org/DTD/wml_1.1.xml”>
<wml>
<template>
<do type=“options” label=“Utils” name=“utils”>
<go href=“http://mmm.pgsm.hu/utils.wml”/>
</do>
</template>
<card id=“phone9110” title=“Nokia 9110*”>
<p align=“center”>
Now it's easy to take the office with you. The Nokia 9110 Communicator
for Europe and Asia-Pacific is a phone, fax, Internet, e-mail, notepad
and calendar - and it fits in your pocket!
</p>
<do type=“options” label=“Technical Specs.” name=“specs”>
<go href=“http://mmm.nokia.com/prod/phones/9110/spec.wml”/>
</do>
<do type=“options” label=“Other Phones” name=“phones”>
<go href=“http://mmm.nokia.com/prod/phones/index.wml”/>
</do>
<do type=“options” label=“Other Products” name=“products”>
<go href=“http://mmm.nokia.com/prod/index.wml”/>
</do>
</card>
</wml>
The modification of the WAP content proxy 112 to include the second
group, that is the addition of the link “Utils”, is the term:
<template>
<do type=“options” label=“Utils” name=“utils”>
<go href=“http://mmm.pgsm.hu/utils.wml”/>
</do></template>

The WAP content proxy 112 is also able to modify the WML page in other ways. For example it can place an indicator such as an asterisk (*) into the header to indicate that new mail has arrived in the mail server of the network operator. In the preceding example, the indicator is added to the title “Nokia 9110” by the term: <card id=“phone9110” title=“Nokia 9110*”>.

Although in this embodiment of the invention, both of these additions can be made by the WAP content proxy 112, in other embodiments of the invention, they can be provided independently, so that only one is provided.

If the pages of other applications are being modified, this has to be done carefully. This is because a WAP terminal 106 usually has a limitation on the page size which is downloadable into its browser's buffer. In case of the Nokia 7110 mobile phone it is 1.3 Kbytes. The additional link inserted by the WAP content proxy 112 increases the size of the WAP page (by approximately 20 bytes) and, if the size of the original page is close to the size limit of the browser's buffer, the modified page will not fit into it. However, although it is expected that different WAP terminals from different manufacturers will have different buffer sizes, they will probably be large enough to accommodate the extra page size caused by addition of a single link. To be on the safe side, the WAP content proxy 112 should add only one item to the Options menu, which points to the home page of the network operator. Because the WAP browser inserts other items into the Options, such as Quit Browsing and Bookmarks, an additional option is not likely to cause confusion to the user.

Rather than inserting links to the network operator's portal or inserting an indicator indicating activities relating to a service provided by the network operator, other modifications are also possible, for example inserting direct links to advertisements. Advertisements may be placed in WML pages specifically provided by the network operator or in WML pages provided by other entities, such as other network operators.

According to the invention, if during browsing content from a commercial site, for example a bookshop, a user selects the home page, the request for the home page can be configured to contain information relating to the bookshop page so that the gateway server can determine the nature of the previous page and act based on that information. Although it would be possible for the gateway to monitor history and traffic, it is advantageous if this only happens in response to some kind of trigger activity, in this case in response to a request for the home page. This allows targeted advertisements to be made, that is when home page information is sent to the terminal, extra material, in the form of advertisements can be added which are determined by the nature of the previous page. The preferred way in which the WAP gateway 118 receives the previous page is for the inserted link to have attribute “sendreferer” set as true, so that the URL of the WML page is sent as a Referer header as part of the request when user activates the link.

FIG. 5 shows an example WML utility page as presented by a browser in the display of a WAP terminal 106. The WML page is obtainable by activating the “Utils” link in FIG. 4 above. The page contains a plurality of utility links including “Mailbox”, “Stock News”, “Joke of The Day” and “Weather Forecast”, an advertisement link “Order Books Now with 15% Discount!” and menu selectors “Options” and “Back”.

Selection of the selector “Options” changes the display to display two groups of available options, as shown in FIG. 6. The first group is an option link which takes the user back to the application that has just been interrupted and an advertisement link corresponding to the advertisement in FIG. 5. Since selection of the selector “Options” makes the WML utility page of FIG. 5 disappear and displays the available options, the advertisement link appears in the options menu as well as being a link in the WML utility page. The second group is options which have been placed by the browser of the WAP terminal and includes “Home”, “Bookmarks”, “Settings” and “Exit Browsing”.

Although the invention is described as being implemented as the part of the WAP gateway, it may be implemented as a proxy between the WAP gateway 108 and the content provider or between the WAP gateway 108 and the mobile network side 102. It is advantageous to implement the invention as part of the WAP gateway 108. If the WAP content proxy 112 is located between the gateway and the WAP terminal 106, then it deals with compiled content which requires decompiling and then compiling again. However, although this would not be as efficient and would be slower than the preferred embodiment, it does enable the WAP content proxy 112 to be used in conjunction with separate WAP gateways, for example those from a variety of manufacturers. However, if WAP security is active this arrangement is not possible since the WAP content proxy 112 would be unable to decompile the compiled content.

Two further embodiments of the invention will now be described.

The first embodiment relates to assembling and accessing a list of bookmarks.

The user of a WAP terminal 106 is able to add bookmarks to a private collection, which is shown in, or accessed via, the user's homepage. The user uses a WAP terminal to browse websites containing WML content pages. Each content page which is sent to the WAP terminal 106 contains an additional link which leads the home page to the WAP terminal 106. Whenever the user browses a content page from a URL which is desired to be saved as a bookmark, the user selects the additional link to receive the home page. The home page contains a bookmark link and selection of this bookmark link leads to the presentation of a number of other links including “select bookmark” or “save present bookmark”. Selection of the “save present bookmark” link causes the desired URL to be saved as a bookmark in a network-based bookmark server. In order for the network-based bookmark server to receive the desired URL, it can either be transmitted by setting sendreferer as true or, if the network-based bookmark server keeps a history of the browsing session, then it already has the URL available so that it can be saved.

The network-based bookmark server has the following elements:

an administration unit which carries out an administration role of enabling/disabling and configuring the feature;

a user database in which the browsing history information is kept (it may also sort the history information which is generated by the filter service handler); and

a servlet which generates browsing history WML pages by carrying out the following sub-functions: adding, changing, removing, and navigating of bookmarks navigating (that is retrieves content from bookmarked pages).

A servlet can be an applet that runs on the server side. A servlet is one way to generate dynamic pages on a server. Servlets are used for extending and enhancing web servers. They provide a component-based, server- and platform-independent method for building web-based applications.

A WAP terminal 106 is used to access the bookmarks on the network-based server. Instead of selecting the “save present bookmark” link in the bookmark content page, the “select bookmark” is selected. This causes a content page to be presented to the user which contains all of the saved bookmarks. Since there may be a problem in presenting all of the bookmarks in the display of the WAP terminal 106 in one page, a link may be provided to allow the user to obtain further content pages containing a continuation of the list of bookmarks.

Although it is preferred that the bookmarks are in a private collection which is only accessible by the user of the second terminal, other individuals or entities may be given permission to access the bookmarks. In one embodiment, this is done by the bookmark server offering configuration options to the user to authorise other users (certain specified users or all users) to access the bookmark list. The bookmark list of an authorising user can be accessed by an authorised user browsing a URL identified as being the location of the bookmarks. The URL can be either typed in the authorised user, or browsed through a content page provided by the bookmark server containing all bookmark lists that the authorised user has access to.

It is not essential that the network-based server which is used to store the bookmark is under the control of the operator of the mobile network 102. In fact, the bookmarks link may take lead to a server which is control by a third party which is authorised by the operator of the mobile network 102.

Although in the foregoing, access to the network-based server for is described as being obtained through the home page, in an alternative embodiment, the link which is inserted into retrieved content pages goes directly to the network-based bookmark server.

An advantage of this embodiment of the invention is that it can be used while browsing and thus the browsing terminal which locates a desired bookmark can save that bookmark in the network-based server. In this way, an additional WWW terminal is not required. However, it should be noted that the list of saved bookmarks may be accessible to a WWW terminal in order that they may be added to, edited, deleted or some other function.

The second embodiment of the invention relates to assembling and accessing a browsing history. A browsing history is a collection of content pages or URLs accessed by a user and continually stored (by the client or the server) without a decision being made by the user. In this embodiment, the browsing history is stored in a network-based browsing history server. During browsing the browsing history server keeps a record of the URLs from which content has been taken. A pre-defined number of URLs are stored. This may be the last certain number of URLs which have been browsed or the URLs which have been browsed over a specified period of time. For example, it may be that the last five, ten, twenty, thirty, forty, fifty or even hundred URLs may be stored. Each URL of the browsing history is stored so that it has associated with it a plurality of parameters including title, URL, first visited, last visited and visit count contained within in separate data fields. Accordingly, the browsing histories are stored in the form of a table or stored in a way in which the can be presented to a user as being a table. The data fields of the URLs may be individually viewable and sortable. They may also be searchable. For example, the searching or the sorting can be on the basis of when browsing occurred or the number of visits which have been to a particular URL. The network-based bookmark server and the network-based browsing history server may be the same server or may be housed in the same unit.

The network-based browsing history server has the following elements:

an administration unit which carries out an administration role of enabling/disabling and configuring the feature (for example defining the maximum history size which is kept);

a filter service handler which collects the history information;

a user database in which the browsing history information is kept (it may also sort the history information which is generated by the filter service handler); and

a servlet which generates browsing history WML pages by carrying out the following sub-functions: listing, cleaning, sorting, and navigating (that is retrieves content from bookmarked pages).

The network-based browsing history server can be in the same functional unit as the WAP content proxy 112. They may be present in the same server. Of course, they can be located separately.

The URLs contained within the network-based browsing history server are selectable in order that they may be saved in the list of bookmarks in the network-based bookmark server. When a URL is selected from the browsing history, a user is given a choice of two options, one to browse the URL and one to save it as a bookmark. If the option to save the URL as a bookmark is chosen a command is sent to the network-based bookmark server requesting that the URL be stored. The command is sent by activation of a link which is automatically inserted into content pages which are sent to the WAP terminal 106 as has been described in the foregoing.

The invention provides a way of adding content to WAP pages from a central location, that is the WAP application server in the network, by the WAP content proxy 112. In this way, the added content can be accessed any time, from any WAP content proxy 112 makes it possible for users always to have available the home page of the network operator. This is better than providing individual options for these services since if they were to be provided all of the time, they would consume a lot of space. If the home page is provided with interesting and useful utilities such as access to a mail server, a search engine and other information resources, then users will be more inclined to use the home page of the network operator as their default home page. Since the network operator can place in the home page advertisements and links to commercial enterprises such as shops, this can enhance the revenue generating capabilities of the network.

A significant advantage of the invention is that it is network based and so can be implemented without requiring any changes to mobile terminals which use the associated service which is provided.

Particular implementations and embodiments of the invention have been described. For example, any links added may direct a user to home pages other than that of the network operator and any indications added may relate to services other than those provided by the network operator. It should be clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method of data transmission between a network (102) and a plurality of terminals (106), the network comprising a gateway (108) via which a terminal having a display can access a plurality of data resources (110, 118) each having stored therein at least one content page, the method comprising the steps of:
the terminal sending a request to the gateway for at least one content page to be provided by at least one of the plurality of data resources;
the gateway providing the at least one content page to the terminal for display in the display of the terminal; and
the gateway inserting into the at least one content page which it provides to the terminal a link which enables the terminal to obtain data from a network address determined by the gateway.

2. A method according claim 1 characterised in that the link is presented in the at least one content page so that the link is visible in the display.

3. A method according claim 1 or claim 2 characterised in that the link is presented in an options field associated with the at least one content page.

4. A method according any preceding claim characterised in that the link is to a home page

5. A method according claim 4 characterised in that the home page provided is controlled by an entity which provides the gateway (108).

6. A method according any of claims 1 to 3 characterised in that the link is to a network-based data resource at which can be stored the address of the at least one content page being browsed to a bookmark list.

7. A method according any preceding claim characterised in that the terminal (106) is a mobile terminal.

8. A method according any preceding claim characterised in that the network (102) is a cellular network for transmitting telephone calls and/or data calls.

9. A method according any preceding claim characterised in that the plurality of data resources (110, 118) comprises a plurality of content servers in the Internet (116).

10. A method according any preceding claim characterised in that the plurality of data resources (110, 118) comprises one or more content servers (110) in the network (102).

11 A method according claim any preceding claim characterised in that the gateway (108) and the terminal (106) communicate by WAP.

12. A method of data transmission over a network (102) controlled by a network operator, the network comprising a gateway (108) via which a terminal (106) having a display can access to a plurality of data resources (110, 118) each having stored therein at least one content page, the method comprising the steps of:
the terminal sending a request to the gateway for at least one content page to be provided by at least one of the plurality of data resources;
the gateway providing the at least one content page to the terminal for display in the display of the terminal; and
the gateway inserting into the at least one content page which it provides to the terminal an indicator which indicates information concerning a service provided by a service provider.

13. A method according to claim 12 characterised in that the indicator indicates that new mail has arrived into a mail server.

14. A method according to claim 12 or claim 13 characterised in that the service provider is the network operator.

15. A data transmission system (100) comprising a network (102) controlled by a network operator, the network comprising a gateway (108) via which a plurality of terminals (106) can access a plurality of data resources (110, 118) each having stored therein at least one content page, each of the terminals having a display, a browser and a transceiver (107), the browser and the transceiver being used by the terminal to send a request to the network for at least one content page to be provided by at least one of the plurality of data resources, the network receiving the request and providing the at least one content page to the terminal for display by the terminal, the gateway comprising a content proxy to insert into the at least one content page provided to the terminal an indicator which indicates information concerning a service provided by a service provider.

16. A gateway (108) for use in a network (102) controlled by a network operator, the network being accessible by a plurality of terminals (106) to access a plurality of data resources (110, 118) each having stored therein at least one content page, each of the terminals having a display, a browser and a transceiver (107), the browser and the transceiver being used by the terminal to send a request to the network for at least one content page to be provided by at least one of the plurality of data resources, the network receiving the request and providing the at least one content page to the terminal for display by the terminal, the gateway comprising a an indicator which indicates information concerning a service provided by a service provider.

17. A content proxy (112) for use in a network (102) controlled by a network operator, the network being accessible by a plurality of terminals (106) to access a plurality of data resources (110, 118) each having stored therein at least one content page, each of the terminals having a display, a browser and a transceiver (107), the browser and the transceiver being used by the terminal to send a request to the network for at least one content page to be provided by at least one of the plurality of data resources, the network receiving the request and providing the at least one content page to the terminal for display by the terminal, the content proxy inserting into the at least one content page provided to the terminal an indicator which indicates information concerning a service provided by a service provider.

18. A computer program product comprising a computer readable medium having thereon:
computer executable code means to provide a gateway (108) for use in a network (102) controlled by a network operator, the network being accessible by a plurality of terminals (106) to access a plurality of data resources (110, 118) each having stored therein at least one content page;
computer executable code means to enable the gateway to receive from at least one of the terminals a request for at least one content page to be provided by at least one of the plurality of data resources;
computer executable code means to request the at least one content page;
computer executable code means to insert into the at least one content page which is provided to the at least one terminal an indicator which indicates information concerning a service provided by a service provider; and
computer executable code means to enable the gateway to provide the at least one content page to the terminal for display in the display of the at least one terminal.
